(19) United States
(12) Patent Application Publication
(10) Pub. No.: US 2008/0271058 A1
(43) Pub. Date: Oct. 30, 2008

(54) TANGIBLE INTERFACE FOR MOBILE MIDDLEWARE

(75) Inventor: Sailesh Sathish, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/742,500

(22) Filed: Apr. 30, 2007

(51) Int. Cl. G06F 13/00

(52) U.S. Cl. 719/328

(57) ABSTRACT

A system and method for enabling the use of tangible user interfaces with applications on mobile devices. Semantic tagging can be used in connection with everyday objects, with the semantic tags providing semantic information about the object at issue. The semantic tags are configured to belong to an ontology that is understood by mobile middleware. The mobile middleware can scan for the presence of tangible interfaces. The tangible interfaces are then populated to a context representation model so that they can be shared by one or more applications.

### FIELD OF THE INVENTION

The present invention relates generally to user interfaces. More particularly, the present invention relates to the implementation and use of tangible user interfaces.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In contrast to conventional user interfaces (UIs), “tangible UIs” enable individuals to use everyday objects to control various information technology (IT) applications. As used herein, tangible UIs refer to everyday objects that users can hold and manipulate through spatial changes, orientation changes, temporal changes, etc. in order to control the function of various applications. One example of a tangible UI is a conventional paintbrush which can be used to “paint” objects in a paintbrush application that is running on a handheld device or laptop computer. Another example of a tangible UI is a container including sensors therein that enable a mobile device to estimate the amount of food in the container. Still other examples of tangible UIs include various dials that can be used to control volume, brightness levels, etc.

Tangible UIs are used as part of a “smart space,” which is a multi-user, multi-device dynamic interaction environment that is aware of its physical environment. Such smart spaces work on top of heterogeneous radio technologies and software distribution platforms. Providing smart space capabilities requires supporting a heterogeneous environment within which devices and services communicate. This support involves hiding the complexities of any underlying network and communication technologies, thereby abstracting the concepts to applications, end users and developers.

In recent years, there has been a substantial amount of research in the area of tangible UIs. However, this research has, for the most part, been restricted primarily to university laboratories. With an eye towards the next generation interaction of mobile telephones, tangible UIs and other aspects of ubiquitous computing are expected to form the core for advanced interaction. Although there are currently a few systems in place that make use of a tangible UI, the tangible UI in these systems is tightly coupled to the applications that they are supposed to interact with. There is therefore currently no generic mechanism for pulling tangible UI data to applications so that virtually any type of object can be used without hard coding their support within the application at issue.

### SUMMARY OF THE INVENTION

Various embodiments of the present invention provide a system and method for more generically using a tangible UI in connection with various applications. Various embodiments involve the use of semantic tagging in connection with everyday objects, with the semantic tags being used to provide semantic information about the object at issue. The semantic tags are configured to belong to an ontology that is understood by mobile middleware. In various embodiments, the middleware discovers tangible interfaces that provide semantic descriptions. These tangible interfaces are then populated to a context representation model so that they can be shared by several applications.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a graphic representation showing the interaction between an object and a mobile device according to various embodiments of the present invention;

FIG. 2 is a flow chart showing an example implementation of one embodiment of the present invention

FIG. 3 is a perspective view of an electronic device that can be used in conjunction with the implementation of various embodiments of the present invention; and

FIG. 4 is a schematic representation of the circuitry which may be included in the electronic device of FIG. 2.

### DETAILED DESCRIPTION OF THE PREFERRED EMBODIMENTS

Various embodiments of the present invention provide a system and method for more generically using a tangible UI in connection with various applications. Various embodiments involve the use of semantic tagging in connection with everyday objects, with the semantic tags being used to provide semantic information about the object at issue. The semantic tags are configured to belong to an ontology that is understood by mobile middleware. In various embodiments, the middleware discovers tangible interfaces that provide semantic descriptions. These tangible interfaces are then populated to a context representation model so that they can be shared by several applications.

Various embodiments of the present invention involve the use of an ontology or other system for describing various instances, classes, attributes, relationships, etc. More particularly, an ontology is used to define basic data types and higher level abstractions that use subsets of the basic data types. Groupings of these high level abstractions serve to define a particular profile of one or more objects.

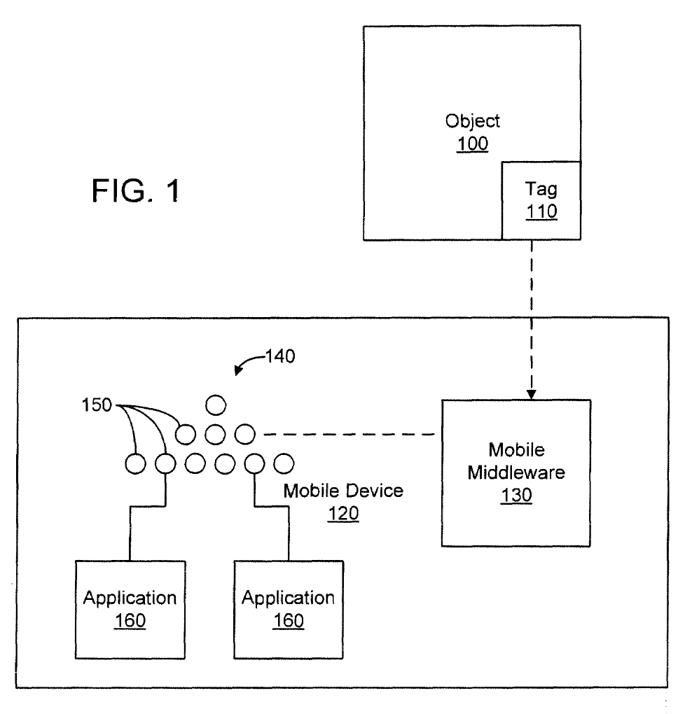

FIG. 1 is a graphic representation showing the interaction between an object 100 and a mobile device 120 according to various embodiments of the present invention. As shown in FIG. 1, whenever the mobile middleware 130 of the mobile device 120 comes into focus or is otherwise in communication with a semantic tag 110 for the object 100, a defined profile contained within the semantic tag 100 is exported to the mobile middleware 130. This exportation can be conducted, for example, using Wibree technology. Wibree is a technology which uses low-powered radio chips for connectivity between objects and Wibree/Bluetooth enabled devices within a certain distance, such as about ten meters.

Once sent to the middleware 130, the profile is scanned by the middleware 130 and is exposed to various applications 160 by having at least one new node 150 formed for the profile within a Delivery Context Interfaces (DCI) tree 140. A DCI tree is a mechanism through which applications can access delivery context information using a Document Object Model (DOM)-like interface. Applications can register event listeners on property nodes that indicate events based on property changes or other changes. For example, an event listener can be associated with a “volume control” node, listening for changes in the object associated with the volume control. In terms of the profiles discussed herein, each profile includes a set of nodes 150, each corresponding to a particular control within the object, and each control has a corresponding node 150 within the DCI tree 140.

Whenever the value of a particular control changes, a new sub-profile corresponding to the control value that has changed is sent by the object to the mobile middleware 130. The mobile middleware 130 then updates the new value for the control within the DCI tree 140. Any event handler that is attached by applications 160 to a particular control is invoked upon such an update. During this process, event handlers are invoked in a way that corresponds to the application 160 currently in focus (i.e., the application that is being used by the user). In the event that there are applications which want to be called even if they are not in focus, these applications 160 can set a “call back” parameter in the event handler, or the applications 160 can register themselves for such a callback service in the top node of the DCI tree 140 through an extension interface in DCI tree 140.

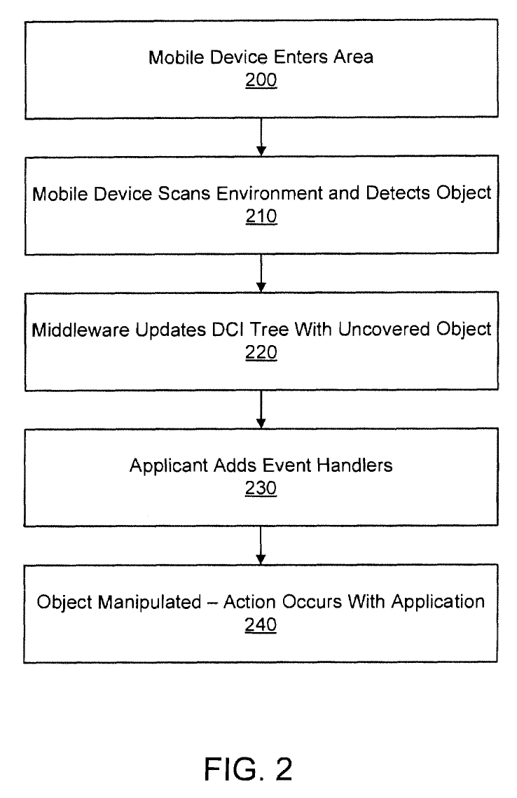

FIG. 2 is a flow chart showing an example implementation of one embodiment of the present invention. At 200 in FIG. 2, the mobile device enters a room or otherwise comes into communication range with an object including a semantic tag. At 210, the mobile device scans the environment for any tangible devices with which a user could interact in conjunction with an application. At 220, upon detecting an object which qualifies as a tangible UI, the middleware in the mobile device updates the mobile device's DCI tree with the name of the uncovered object. The name of the object that is used for the DCI tree corresponds to an entry within the standard ontology. In other words, “standard” names are used for the objects so that they can be readily identified and categorized inside the DCI.

Through the use of standard names, an application on the mobile device can readily identify names of objects in which the application would be interested. For example, an ontology can include the name “volume control” for a knob or dial on a stereo for adjusting the stereo's volume. Similarly, the middleware can identify the “volume control” name and thereby efficiently add a new node under a specific portion of the DCI tree.

At 230, an application of interest adds event handlers corresponding to the object that has been uncovered. For example and using the “volume control” example, if an application knows that it could use the “volume control,” it can add event handlers for notifications on top of the parent node that contains “volume control” nodes. Alternatively, the application can look for events that inform the application about new node additions and, when a new node has been added, the application can attach an event handler directly to that node. Thus, applications can attach or listen for nodes that they think can be mapped to application functionalities, providing for a generic middleware for tangible UIs that can be shared across application instances. Whenever a value of an object changes, the event handler is called, thereby notifying the application that the value has changed. When attached to an application, a manipulation of the object at 240 results in an appropriate action in the application(s) to which the object is attached. Therefore, for example, if the “volume control” is attached to a media player, then a turning down of the “volume control” results in the volume on the media player being lowered.

Each tangible UI can offer different controls, in which each control possesses a corresponding entry within the DCI tree. For example, a stereo can include a “volume control,” a “treble control,” a “bass control,” a “pause function”and others. Several applications running on a platform can choose which of these controls they can use for their respective application by adding event handlers for that particular control. This enables a single set of tangible UIs to be shared between multiple applications.

The middleware on the mobile device can control which application(s) receive notifications. This is accomplished by dynamically managing the event handlers so that the event handler for an application in focus gets called in case there are handlers attached to the same tangible UI from different applications. For example, if a particular media player is active, then the changing of the volume on the “volume control” should not affect other applications that may be using the same control for another purpose. This can be implemented through cooperation between the DCI implementation and the middleware.

For each tangible UI, there are a number of different requirements for basic data types in the ontology. In the DCI tree, there is a value parameter for all objects that are represented. There is also a value type associated that indicates the value type to the application. This value can comprise an integer, a double integer representation or a string. Alternatively, the value type can be augmented with additional parameters such as orientation, weight, etc. that provide additional information about what that value actually refers to so that any calling application knows how to read the value parameter. The value type can indicate whether the value is an integer, a long integer, or something else. An additional parameter (which can be part of the DCI metadata interface) indicates what that value actually means, i.e., how it should be interpreted. For example, an orientation value can comprise an integer. In the metadata for that object, there would be a parameter that informs the application that this object provides orientation information so that the integer value is interpreted as a degree value.

In addition to data types such as int (integer), long (long integer), double (double integer), etc. which form the first level of abstraction, other data types are listed below. It should be noted, however, that the following data types are not intended to be exhaustive, and the usage of the individual data types is dependent upon the tangible object at issue.
Range (denoting value ranges that are supported by the tangible object)
Orientation
Weight
Shape (this can corresponds to standard shape if applicable)
Color
Build material
Value: current value
Owner
Spatial orientation
Location
Time (where applicable)
History (where applicable regarding usage)
Number of controls
Name
URI/Namespace (there can be a default namespace)
Metadata (e.g., creation date, manufacturer, etc.)
Granularity (of output)
Application groups (generic application groups for which this can be used)
Application (specific application for which this can be used)
Linkage (other TUI's that can be affected by change in this object—where applicable)
Icon/Image (this parameter can point to an icon or image (e.g., a URI or binary image) that represents the tangible UI so that a UI manager can render this image. In cases where this parameter is not given, the UI manager can refer to the ontology to determine which icon to use to visually show the tangible object to user.)
Auditory icons (for example, a sound clip may be played when something changes in the tangible UI so that the user becomes aware of the object through sound. Such an item can be a URI to a sound clip or a binary of the sound file itself.)

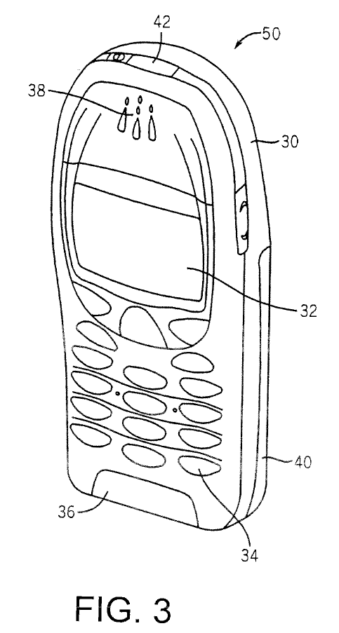

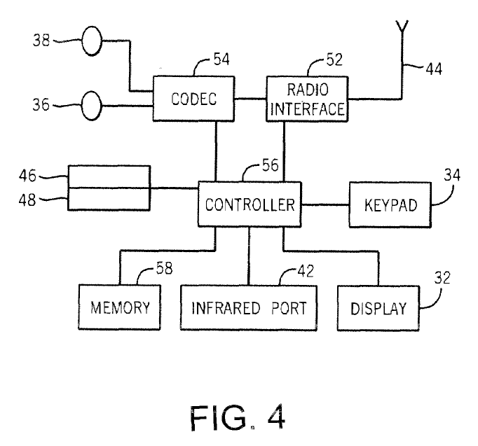

FIGS. 3 and 4 show one representative electronic device 50 within which the present invention may be implemented. It should be understood, however, that the present invention is not intended to be limited to one particular type of device. The electronic device 50 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various embodiments of the present invention described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated.

What is claimed is:

1. A method, comprising:
detecting an object identified by a name in an ontology;
determining whether the object as identified by the name is usable with an application on a device; and
if the object as identified by the name is usable with the application, associating the object with the application as a tangible user interface.

2. The method of claim 1, further comprising, upon detecting the object, forming a node on a delivery context interfaces tree corresponding to the detected object.

3. The method of claim 2, wherein the associating of the object of the application comprises having the application add an event handler to the node.

4. The method of claim 2, wherein the associating of the object of the application comprises having the application add an event handler to a parent node that includes the node thereunder.

5. The method of claim 2, wherein middleware is used to form the node on the delivery context interfaces tree.

6. The method of claim 2, wherein the node possesses a changeable value representing a current state of the object, and further comprising:
detecting a change in the changeable value of the node; and
if the application is in use, adjusting at least one feature in the application to reflect the change in the changeable value.

7. The method of claim 1, wherein the object is detected via a semantic tag associated with the object.

8. The method of claim 1, wherein the semantic tag includes an identification of a plurality of properties associated with the object.

9. The method of claim 1, wherein the object is detected using Wibree technology.

10. A computer program product, embodied in a computer-readable medium, comprising computer code configured to perform the processes of claim 1.

11. The computer program product of claim 10, further comprising computer code for, upon detecting the object, forming a node on a delivery context interfaces tree corresponding to the detected object.

12. The computer program product of claim 11, wherein the associating of the object of the application comprises having the application add an event handler to the node.

13. The computer program product of claim 11, wherein the associating of the object of the application comprises having the application add an event handler to a parent node that includes the node thereunder.

14. The computer program product of claim 11, wherein middleware is used to form the node on the delivery context interfaces tree.

15. The computer program product of claim 11, wherein the node possesses a changeable value representing a current state of the object, and further comprising:
detecting a change in the changeable value of the node; and
if the application is in use, adjusting at least one feature in the application to reflect the change in the changeable value.

16. The computer program product of claim 10, wherein the object is detected via a semantic tag associated with the object.

17. The computer program product of claim 16, wherein the semantic tag includes an identification of a plurality of properties associated with the object.

18. An apparatus, comprising:
middleware configured to detect an object identified by a name in an ontology; and
an application configured to determine whether the object as identified by the name is usable with the application, and if the object as identified by the name is usable with the application, associate with the object as a tangible user interface.

19. The apparatus of claim 18, wherein the middleware is further configured to, upon detecting the object, form a node on a delivery context interfaces tree corresponding to the detected object.

20. The apparatus of claim 19, wherein the associating of the object of the application comprises having the application add an event handler to the node.

21. The apparatus of claim 19, wherein the associating of the object of the application comprises having the application add an event handler to a parent node that includes the node thereunder.

22. The apparatus of claim 19, wherein the node possesses a changeable value representing a current state of the object, and wherein the application is further configured to adjust at least one feature in the application to reflect a detected change in the changeable value if the application is in use.

23. The apparatus of claim 18, wherein the object is detected via a semantic tag associated with the object.

24. The apparatus of claim 23, wherein the semantic tag includes an identification of a plurality of properties associated with the object.

25. The apparatus of claim 23, wherein the object is detected using Wibree technology.

26. An apparatus, comprising:
means for detecting an object identified by a name in an ontology;
means for determining whether the object as identified by the name is usable with an application on a device; and
means for, if the object as identified by the name is usable with the application, associating the object with the application as a tangible user interface.

27. The apparatus of claim 26, further comprising means for, upon detecting the object, forming a node on a delivery context interfaces tree corresponding to the detected object.

28. The apparatus of claim 27, wherein the associating of the object of the application comprises having the application add an event handler to the node.

29. The apparatus of claim 27, wherein the associating of the object of the application comprises having the application add an event handler to a parent node that includes the node thereunder.

30. The apparatus of claim 27, wherein the node possesses a changeable value representing a current state of the object, and further comprising:
means for detecting a change in the changeable value of the node; and
means for, if the application is in use, adjusting at least one feature in the application to reflect the change in the changeable value.

31. The apparatus of claim 26, wherein the object is detected via a semantic tag associated with the object.
